(19) United States
(12) Patent Application Publication
(10) Pub. No.: US 2008/0182741 A1
(43) Pub. Date: Jul. 31, 2008

(54) CARTON CONVEYOR FLIGHT BAR WITH FOLDING STRUCTURE

(76) Inventors: John J. Hunter, Canton, GA (US); John W. Cash, Dallas, GA (US)

Correspondence Address: MEADWESTVACO CORPORATION, 1021 MAIN CAMPUS DRIVE, CENTENNIAL CAMPUS, RALEIGH, NC, 27606, US

(21) Appl. No.: 12/023,587

(22) Filed: Jan. 31, 2008

Related U.S. Application Data
(60) Provisional application No. 60/887,552, filed on Jan. 31, 2007.

(51) Int. Cl. B31B 1/26; B31F 1/00; B31B 49/02

(52) U.S. Cl. 493/436; 493/468

(57) ABSTRACT

A system for folding cartons includes a carton conveyor for supporting and transporting cartons in a flow direction along a path, an active folding element, flight bars, and folding structures. A space for receiving a carton is defined by a conveying surface of the carton conveyor and support surfaces of the flight bars. The folding structures protrude into the space and are positioned to contact a carton proximate to a fold line to facilitate folding the carton with the active folding element.

### RELATED APPLICATIONS

This application claims priority to U.S. Application No. 60/887,552, filed Jan. 31, 2007, the entirety of which is incorporated herein by reference.

### TECHNICAL FIELD

This invention relates generally to packaging systems and, more specifically, to systems that include a flight bar with features that facilitate closing the open ends of cartons conveyed on a carton conveyor.

### DESCRIPTION OF THE RELATED ART

Tubular “sleeve type” cartons are typically erected using high speed automatic packaging machines, which rapidly close the ends of the cartons by folding end flaps and gluing them in place. Certain carton designs have end flaps that are connected to one another by gusset panels. For example, ice pack cartons have gusset panels that connect side end flaps to a bottom end flap so as to provide a water-tight carton bottom. However, these gusset panels are difficult to fold consistently and completely with a conventional apparatus that is used to fold tubular cartons that do not include gusseted end closures.

For example, a folding apparatus typically includes active folding wheels that fold the side end flaps of tubular cartons and a static folding guide that folds the bottom and top end flaps of conventional tubular cartons. Folding an arrangement of end flaps that are connected by gusset panels with a folding wheel or folding guide can be problematic in that folding one of the flaps of the arrangement causes the other flaps of the arrangement to substantially simultaneously fold, making it difficult to prevent undesirable creasing and buckling of the gusset panel at locations other than along the intended fold lines. Thus, the actual fold locations can differ from the intended fold lines, which represent desired folding locations. Although the intended fold lines may be prescored to encourage the desired fold, the intended fold lines are unbroken before folding the arrangement, so the fold lines are not weakened enough to buckle so as to overcome or control the natural folding tendencies of the arrangement.

Therefore, a heretofore unaddressed need exists in the industry to address the aforementioned deficiencies and inadequacies. What is needed is an improved apparatus and/or method for forming the end closure structures of cartons that have end flaps that are connected to one another by gusset panels.

### SUMMARY

The various embodiments of the present invention overcome the shortcomings of the prior art by providing a system and method for folding cartons such as those that have gusset panels that connect side end flaps to a bottom end flap to provide a water-tight carton bottom. The system and method of the present disclosure consistently and completely folds end panels connected by gussets.

According to an exemplary embodiment of the present invention, a system for folding cartons includes a carton conveyor for supporting and transporting cartons in a flow direction along a path, an active folding element, flight bars, and folding structures. A space for receiving a carton is defined by a conveying surface of the carton conveyor and support surfaces of the flight bars. One or more folding structures protrude from a plane defined by one or more of the support surfaces of the flight bars and into the space. Each folding structure is positioned to contact a carton proximate to a fold line to facilitate folding the carton with the active folding element. For example, the active folding element can be a folding wheel.

In certain embodiments, the folding structure is attached to one of the flight bars. In alternative embodiments, the folding structure is integral to one of the flight bars. In still other embodiments, the position of the folding structure is adjustable.

According to one aspect of the invention, the fold line is in an arrangement of end flaps of a carton. The arrangement can include a side end flap that is connected to a bottom end flap by a gusset panel. Here, the folding structure is positioned to contact a carton proximate to the fold line that hingedly connects the side end flap and the gusset panel. The active folding element is for folding side end flaps of cartons.

According to another aspect of the invention, the first flight bar and the second flight bar are arranged along the path such that the first flight bar is positioned to support the leading side wall of a carton and the second flight bar is positioned to support the trailing side wall of the carton. A folding structure protrudes from at least the support surface of the first flight bar. The folding structure protrudes into the space from one of the flight bars toward the other of the flight bars.

According to another aspect of the invention, the folding structure is shaped to facilitate loading the carton and folding the end flaps of the carton. The folding structure includes a downwardly sloped surface, an inwardly sloped surface, and a tip end.

According to an aspect of the invention, a method for folding end flaps of a carton to form an end closure structure includes placing a carton on a carton conveyor in a space defined by a conveyor surface, a first flight bar, and a second flight bar. The method further includes pre-folding a fold line in an arrangement of end flaps of the carton. The arrangement includes a first side end flap and a bottom end flap that are connected by a first gusset panel. The fold line is pre-folded by a folding apparatus that protrudes into the space. The method further includes folding the first side end flap inward to further fold the arrangement along the fold line and at least partially form an end closure structure. In certain embodiments, the folding step includes operating a folding wheel. The pre-folding step occurs by virtue of the placing step.

The foregoing has broadly outlined some of the aspects and features of the present invention, which should be construed to be merely illustrative of various potential applications of the invention. Other beneficial results can be obtained by applying the disclosed information in a different manner or by combining various aspects of the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

### BRIEF DESCRIPTION OF THE DRAWINGS

FIG. 1 is a partial plan view of a packaging apparatus including a carton conveyor with an exemplary folding structures for pre-folding the end flaps of cartons and a folding station.

FIG. 2 is a partial perspective view of the carton conveyor of FIG. 1.

FIG. 3 is a partial perspective view of an open end of one of the cartons of FIG. 1, the carton having gusset panels interconnecting certain end flaps.

FIG. 4 is an end elevation view of the carton of FIG. 3, the end flaps of the carton being partially folded toward the open end thereof.

FIGS. 5-8 are views of one of the folding structures of FIG. 1.

### DETAILED DESCRIPTION

As required, detailed embodiments of the present invention are disclosed herein. It must be understood that the disclosed embodiments are merely exemplary of the invention that may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods have not been described in detail in order to avoid obscuring the present invention. Therefore, specific structural and functional details disclosed herein are not to be interpreted as limiting, but merely as a basis for the claims and as a representative basis for teaching one skilled in the art to variously employ the present invention.

Referring now to the drawings, wherein like numerals indicate like elements throughout the several views, the drawings illustrate certain of the various aspects of an exemplary embodiment of a packaging apparatus 10 that includes a carton conveyor 100 and a folding station 300.

### Carton

The packaging apparatus 10 is configured to operate with exemplary cartons 200 and is particularly useful for use with end loadable cartons having gusseted end closures, each including at least one gusset panel interconnecting a side end flap and either a top end flap or a bottom end flap. It should be understood that the packaging apparatus 10 can be adapted to transport, load, fold, and secure a variety of carton configurations. For example, the packaging apparatus 10 can be adapted to operate with cartons having different end flap sizes and/or configurations.

Typically, the cartons 200 are partially preformed from carton blanks into collapsed tubular structures before being loaded into a hopper (not shown). Thereafter, the collapsed tubular structures are pulled from the hopper, erected as tubular structures T with open ends N, and deposited on the carton conveyor 100 between flight bars 120 by an erecting apparatus. As used herein, the term flight bar refers to each member that functions to support the tubular structure in an erected condition and that translates the tubular structure along with the carton conveyor 100, albeit not necessarily synchronously. For example, a flight bar may be a frame, lug, bracket, or other means for engaging and supporting the carton as it is conveyed, so that it can be loaded and sealed.

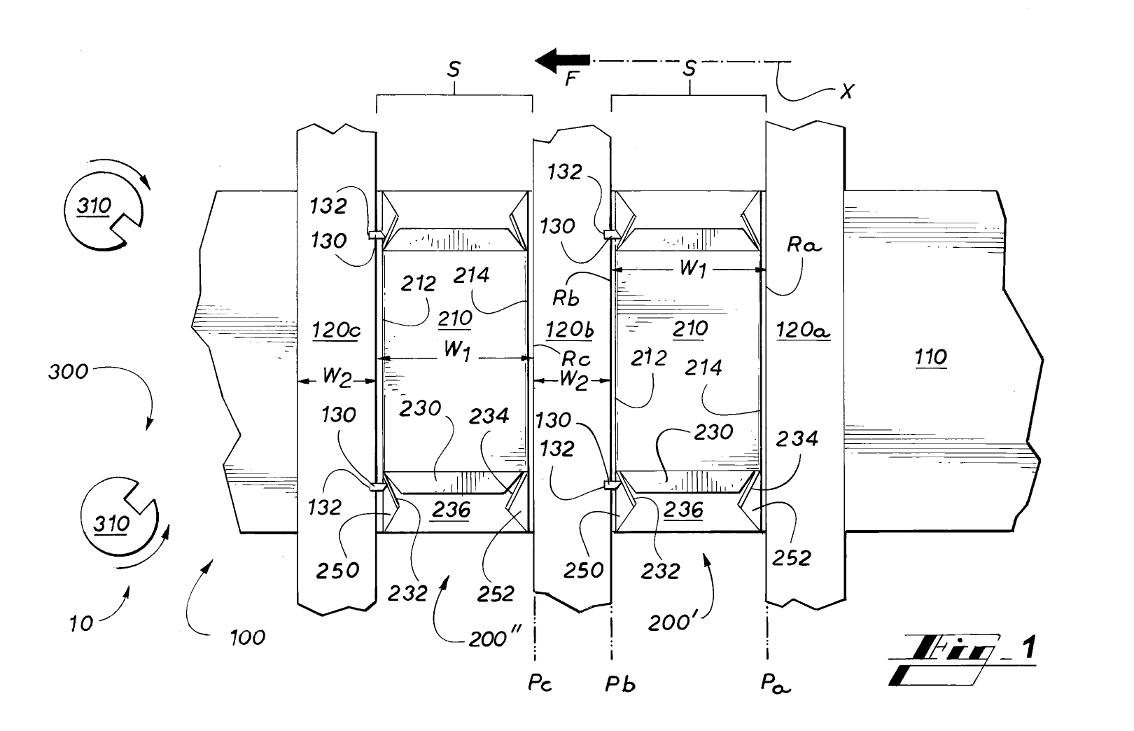

Referring to FIGS. 1-4, walls of the cartons 200 that define tubular structure T include a top wall 210, a bottom wall 216, a first side wall 212, and a second side wall 214 that are hingedly connected to one another along fold lines so as to define corners when the tubular structure T is erected. Further, end flaps are hingedly connected to opposite end edges of each of the walls 210, 212, 214, 216 of the tubular structure T. The end flaps can be folded and secured to form end closures that close, at least partially, the open ends N of the tubular structures T and thereby define end walls of the cartons 200.

For clarity, the end flaps of only one end of the carton 200 are described. It should be understood that each end of the carton 200 is substantially the same and that the apparatus and method described herein can be used to form end closure structures at both ends of the cartons 200. In alternative embodiments, only one end is configured as described.

In the illustrated embodiment, a top end flap 230 is hingedly connected to the top wall 210 along a fold line 240, a bottom end flap 236 is hingedly connected to the bottom wall 216 along a fold line 246, a first side end flap 232 is hingedly connected to the first side wall 212 along a fold line 242, and a second side end flap 234 is hingedly connected to the second side wall 214 along a fold line 244. Further, the bottom end flap 236 includes a fold line 248 that defines an upper portion U and a lower portion L of the bottom end flap 236.

Gusset panels 250, 252 connect the side end flaps 232, 234 to the bottom end flap 236. The gusset panels 250, 252 are hingedly connected to the bottom end flap 236 along fold lines 260, 262 and hingedly connected to the side end flaps 232, 234 along diagonal fold lines 264, 266. The diagonal fold lines 264, 266 extend at an acute angle with respect to the fold lines 260, 262 such that the gusset panels 250, 252 cause the bottom end flap 236 and the side end flaps 232, 234 to fold substantially simultaneously.

As used herein, the terms leading, trailing, upstream, and downstream denote relative position or direction with respect to a flow direction F along a path X. The cartons 200 are positioned on the carton conveyor 100 such that the first side wall 212 is downstream of second side wall 214. Accordingly, first side wall 212 is hereinafter referred to as leading side wall 212 and second side wall 214 is herein after referred to as trailing side wall 214.

Further, suffixes (a, b, or c) or prime designations (′ or ″) are affixed to element numerals that reference-like elements in a general manner so as to differentiate a specific one of the elements. For example, the element number 200 is used generally to reference any or all cartons, the element number 200′ is used to reference the upstreammost carton 200, and the element number 200″ is used to reference the downstreammost carton 200.

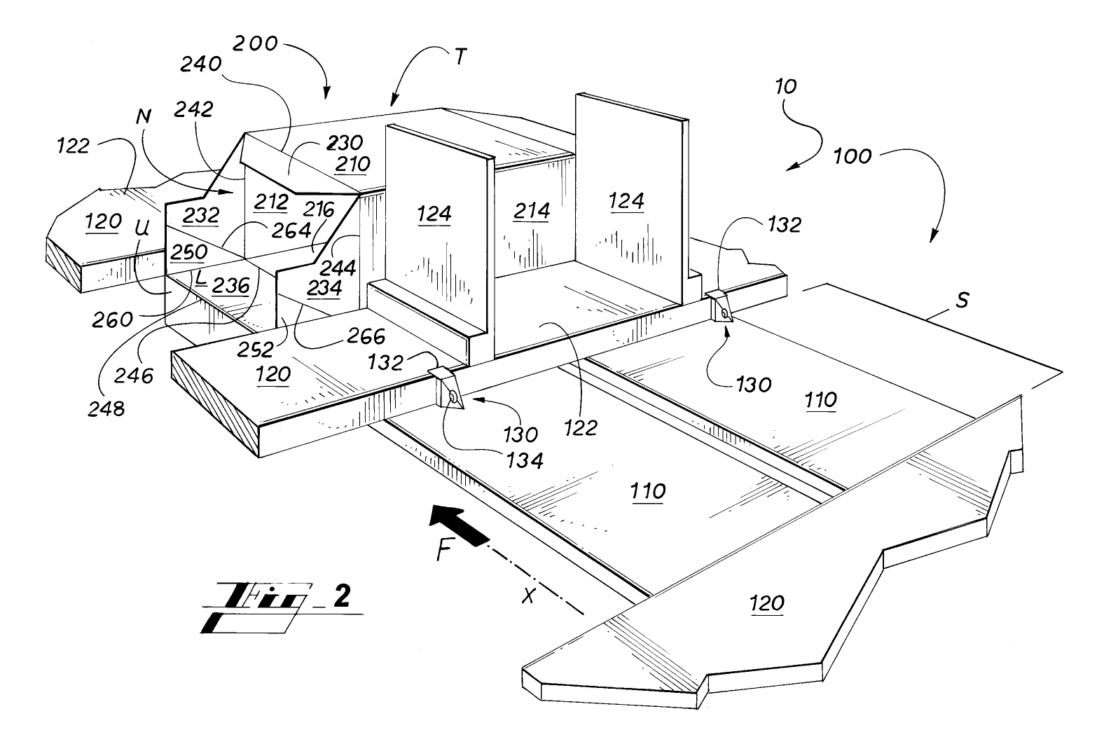

Referring to FIGS. 1 and 2, the illustrated carton conveyor 100 transports the cartons 200 in the flow direction F along the path X through the packaging apparatus 10. The cartons 200 are transported as tubular structures T, as shown in FIGS. 2 and 3, to a loading station (not shown), where they are loaded through one or both open ends N. Thereafter, the loaded cartons 200 are transported to the folding station 300 where the end flaps of the cartons 200 are folded and secured to form end closure structures that enclose the open ends N of the tubular structures T.

### Carton Conveyor

Referring to FIGS. 1 and 2, the illustrated carton conveyor 100 includes a static conveying surface 110 that at least partially defines the path X, and flight bars 120. The flight bars 120 are positioned above the conveying surface 110 and move along the path X. In alternative embodiments, the conveying surface may be formed from a series of plates that are attached to and driven by a roller chain, and flight bars or lugs may be secured to some of the plates. In other words, the conveying surface may be dynamic, and the flight bars, may or may not move in fixed relation to the conveying surface 110.

The flight bars 120 illustrated in FIG. 2 include main portions 122 that extend transversely with respect to the flow direction F and vertical supports 124 that extend upwardly from the main portions 122. It should be understood that the vertical supports 124 can be integral to or attached to the flight bars 120.

Referring to FIG. 1, the flight bars 120 are spaced apart from one another to define spaces S for receiving cartons 200. Specifically, a width W1 of each of the spaces S is defined as the distance between support surfaces R of the flight bars 120. Each support surface R includes one or more surfaces of the flight bar 120 that are substantially coplanar and that contact and support a wall of a carton 200. Accordingly, each support surface R and the supported wall of a carton 200 disposed in the space S defines a plane P.

The flight bars 120 space the cartons 200 from one another, hold the cartons 200 therebetween, and transport the cartons 200 along the path X in the flow direction F. The spacing provided by the flight bar 120b is now described in further detail. It should be understood that the description of the flight bar 120b is applicable to each flight bar 120. The illustrated flight bar 120b supports adjacent cartons 200′, 200″ such that the leading side of the flight bar 120b provides the support surface Rc for the trailing wall 214 of the leading carton 200″ and the trailing side of the flight bar 120b provides the support surface Rb for the leading wall 212 of the trailing carton 200′. Thereby, a width W2 of the flight bar 120b, or otherwise the distance between the support surfaces Rb, Rc that support the adjacent cartons 200′, 200″, defines the spacing between adjacent walls 214, 212 of the adjacent cartons 200′, 200″. In alternative embodiments, multiple flight bars may be positioned between adjacent cartons and each flight bar can provide a support surface or part of a support surface for one or both of the adjacent cartons.

The pair of flight bars 120a, 120b that support and transport the carton 200′ are now described in further detail. It should be understood that the description of the pair of flight bars 120a, 120b and their relationship to the carton 200′ is applicable to each pair of flight bars 120 and a corresponding carton 200. The trailing side wall 214 of the carton 200′ is supported by the leading support surface Ra of the trailing flight bar 120a and the leading side wall 212 of the carton 200′ is supported by the trailing support surface Rb of the leading flight bar 120b.

### Folding Structure

Referring to FIGS. 1-8, the carton conveyor 100 includes a folding structure 130 that facilitates closing the ends of the cartons 200, as described in further detail below. The illustrated folding structure 130 is in the form of a protrusion or wedge that is sculpted and optimally positioned to be attached or integral to the leading flight bar 120b. In an exemplary embodiment, the trailing side of the main portion 122 of the flight bar 120b includes recesses 132 in each of which a folding structure 130 can be received and secured. The folding structure 130 can be secured in the recess by any means for securing including VELCRO type hook and loop fasteners, adhesive, mechanical fasteners, chemical bonding, combinations thereof, and the like. In the illustrated embodiment, an aperture 134 is formed in the folding structure 130 and a bolt can be inserted through the aperture 134 and into a threaded aperture (not shown) in the flight bar 120 to secure the folding structure 130 to the flight bar 120.

Once a folding structure 130 is received and secured in a recess 132, the folding structure 130 extends upstream from the trailing support surface Rb of the leading flight bar 120b and into the space S between the flight bars 120a, 120b where the carton 200′ is received. The folding structures 130 are positioned with respect to features of the carton 200′, as described in further detail below.

In alternative embodiments, for example, where the folding structure 130 is not secured to a flight bar 120, the folding structure 130 can be secured to any structure or positioned in any manner so as to extend from the plane Pb defined by the support surface Rb and provide the functionality described herein.

In alternative embodiments, the leading side of the trailing flight bar 120a additionally or alternatively includes recesses 132 in each of which a folding structure 130 can be received and secured. In such embodiments, folding structures 130 extend downstream from the leading support surface Ra of the trailing flight bar 120a and into the space S between the flight bars 120a, 120b where the carton 200′ is received.

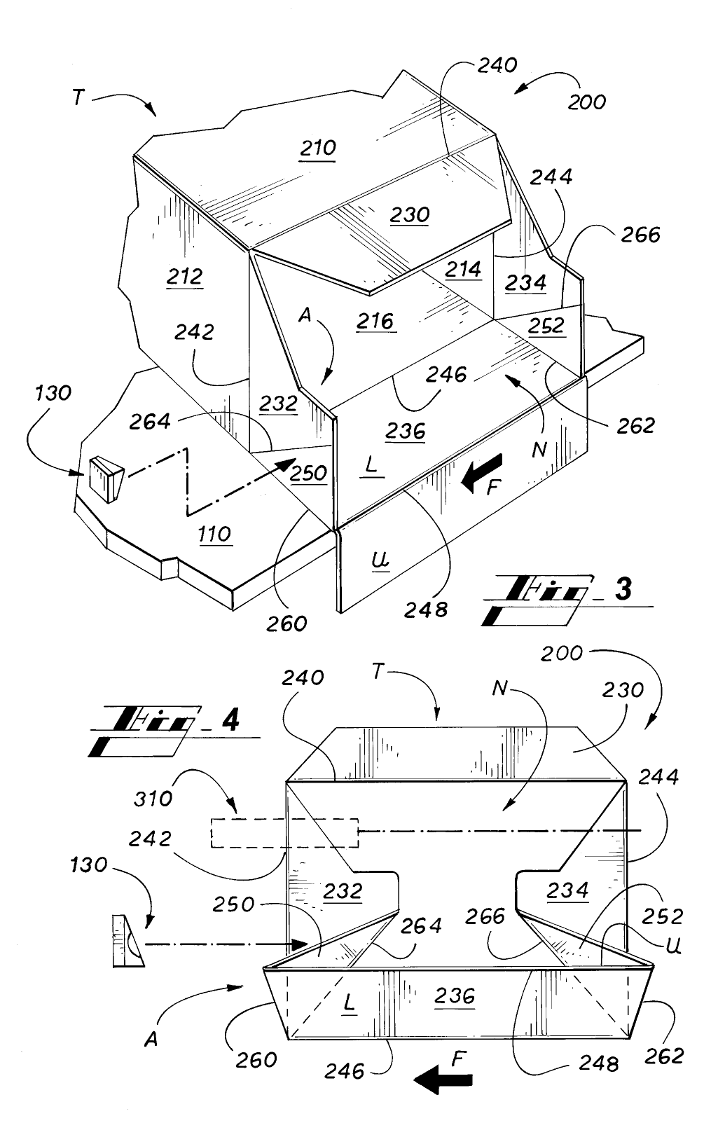

Referring to FIGS. 5-8, the illustrated folding structure 130 is sloped, tapered, dimensioned, or otherwise shaped to facilitate receiving a carton 200 in the space S, facilitate loading articles through the open end N of the tubular structure T, and facilitate folding the end flaps of the carton 200 as described in further detail below.

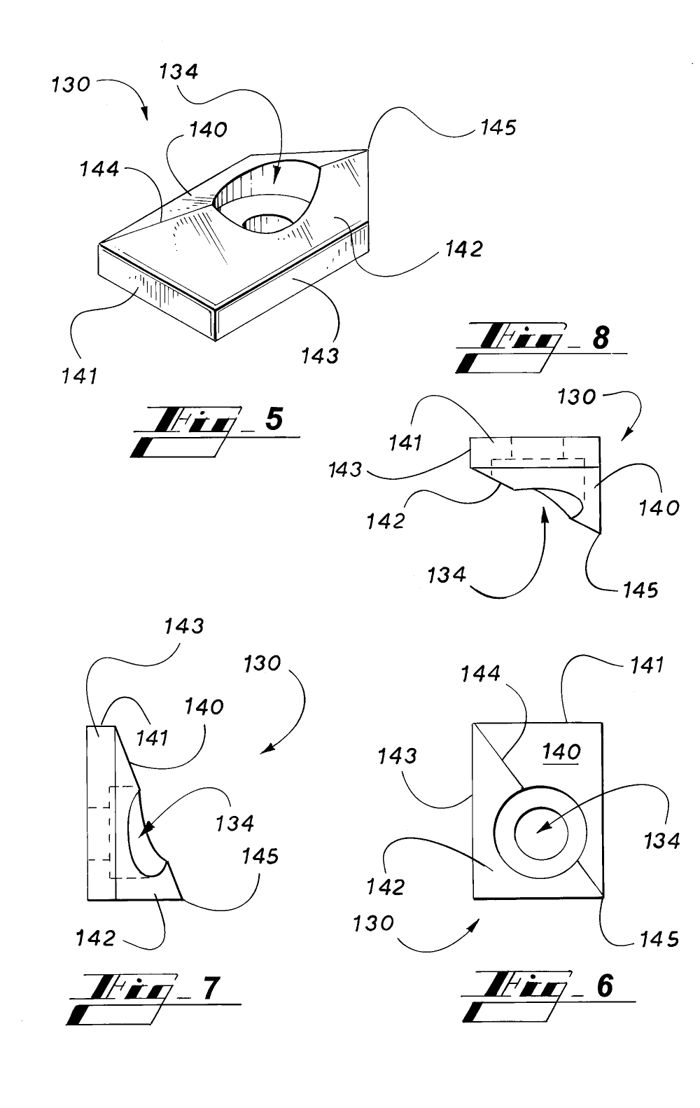

The folding structure 130 includes a downwardly sloped surface 140 (see FIG. 7) and an inwardly sloped surface 142 (see FIG. 8) that meet along a diagonal edge or ridge 144. As used herein, the term downward means in the direction of or toward the conveyor surface. The surface 140 slopes downwardly from a top end 141 to the edge 144 such that, as the erected cartons 200 are received in the spaces S, the end flaps of the carton 200 do not get caught on or are not obstructed by the folding structure 130. Similarly, surface 142 slopes inwardly from an outer end 143 to the edge 144 such that the end flaps do not get caught or are not obstructed as the end flaps are folded to form an end closure structure. In addition, the edge 144 slopes downwardly and inwardly from the corner of the top end 141 and the outer end 143 so that a tip end 145 of the folding structure 130 does not obstruct articles, which are loaded into the open end N of the carton 200. Here, the aperture 134 extends through folding structure 130 so as to interrupt the edge 144 and the surfaces 140, 142.

In alternative embodiments, the sloped surfaces 140, 142 and the diagonal edge 144 can be altered to facilitate folding the end flaps of alternative carton configurations. For example, the disposition of the diagonal edge 144 can change to approximate that of diagonal fold lines 264 of different angles. It is envisaged that the folding structure 130 can have a conical shape or a cylindrical peg shape.

### Folding Station

Referring to FIGS. 1 and 4, the folding station 300 includes folding element(s) (in some embodiments “folding wheels”) 310 for folding the side end flaps 232, 234 (minor end flaps) and static guides (not shown) for folding the top and bottom end flaps 230, 236 (major end flaps). The use of the term “folding wheel” is representative and not intended to be limiting. For the end flap configuration of carton 200, the folding wheel 310 is vertically positioned to contact in sequence upper portions of the side end flaps 232, 234 so as not to obstruct the bottom end flap 236 as the bottom flap 236 is simultaneously folded together with the side end flaps 232, 234.

Hereinafter, for simplicity, the leading side end flap 232, the gusset panel 250, and the bottom end flap 236, which are hingedly connected one to the next along the fold lines 260, 264, are referred to as an arrangement A.

Without the employment of the present invention, as the folding wheel 310 contacts the leading side end flap 232, the arrangement A does not necessarily properly fold along the fold lines 260, 264. It should be understood that the fold lines 260, 264 are provided where the arrangement A is desired to fold and not necessarily where the arrangement A naturally folds. Specifically, the leading side end flap 232 or the gusset panel 250 can fold or bend along a line of weakness or a line of least resistance that differs from the diagonal fold line 264 as the leading side end flap 232 is folded along the fold line 242. It should be understood that the fold lines 260, 264 provide a certain amount of resistance to folding before they are initially folded or broken and that this resistance can cause the arrangement A to fold elsewhere, for example, where the arrangement A naturally folds. Another factor that contributes to the arrangement A being improperly folded is that, since the fold lines 260, 264 connecting the arrangement A are not parallel to one another but rather, radiate divergently from a corner of the carton 200, the arrangement A is intended to fold in a relatively complex manner.

### Method

Referring to FIGS. 1-4, an exemplary method for operating the packaging apparatus 10 to place the cartons 200 in spaces S on the carton conveyor 100 and form the end closure structures of the cartons 200 is now described. As or before the cartons 200 are dropped or otherwise vertically inserted between flight bars 120, the cartons 200 are erected as tubular structures T with the end flaps extending outward to be substantially coplanar with a wall to which each end flap is hingedly connected and with the gusset panels 250, 252 being coplanar with the side end flaps 232, 234. As the cartons 200 are received in the spaces S, the lower portion L of the bottom end flap 236 is in flat face contact with the conveying surface 110 and the upper portion U of the bottom end flap 236 is folded along the fold line 248 and extends downwardly from a side edge of the conveying surface 110.

Assuming, for example, that the carton 200 is erected as a tubular structure T before being vertically inserted between flight bars 120, the lower portion L of the bottom end flap 236 contacts the folding structure 130, slides along the downwardly sloped surface 140, and moves past the tip end 145 of the folding structure 130 and into flat face contact with the conveying surface 110. Thereafter, the tip end 145 of the folding structure 130 is positioned proximate to the diagonal fold line 264. For example, the folding structure 130 can be positioned such that the edge 144 is substantially aligned with the diagonal fold line 264.

Here, the folding structure 130 is positioned with respect to the carton 200 so as to extend from the support surface Rb towards the arrangement A. The folding structure 130 contacts the arrangement A at a selected location and thereby pre-folds the arrangement A along the diagonal fold line 264. This facilitates folding the arrangement A along the fold lines 260, 264, 242. Specifically, the distal or tip end 145 of the folding structure 130 contacts the arrangement A proximate to the diagonal fold line 264 so as to pre-break the diagonal fold line 264 or otherwise to configure the arrangement A such that, as the folding wheel 310 contacts the leading side end flap 232, the arrangement A is properly folded as intended along the fold lines 260, 264, 242.

Further described, the tip end 145 of the folding structure 130 extends from the support surface Rb such that the leading side end flap 232 and the gusset panel 250 are forced or displaced from the support surface Rb (shown in an exaggerated manner in FIG. 4). It should be noted that the protrusion distance, as defined between the tip end 145 of the folding structure 130 and the support surface Rb, and the position of the tip end 145 of the folding structure 130 along the length of the diagonal fold line 264 can be optimized such that folding structure 130 controls the amount of displacement of the leading side end flap 232 and the gusset panel 250. Alternatively described, the dimensions and position of the folding structure 130 can be optimized to control the degree that the diagonal fold line 264 is pre-folded.

For example, to facilitate folding the arrangement A, the folding structure 130 folds the leading side end flap 232 and the gusset panel 250 along the diagonal fold line 264 by a suitable amount so as to pre-break the diagonal fold line 264. It should be understood that the displacement of the leading side end flap 232 and the gusset panel 250 is controlled or otherwise limited so as to not obstruct the process of loading articles through the open end N of the carton 200. As another example, the folding structure 130 configures the arrangement A such that, as the leading side end flap 232 is folded along the fold line 242, the arrangement A folds along the fold lines 260, 264.

Referring to FIGS. 3 and 4, after the carton 200 is loaded by inserting articles (not shown) through an open end N, the carton 200 is transported to the folding station 300 shown in FIG. 1. The folding wheel 310 contacts and folds the leading side end flap 232 along the fold line 242 and, accordingly, the gusset panel 250 folds along the pre-broken diagonal fold line 264 and the fold line 260 and the bottom end flap 236 folds along the fold line 246. Thereby, the outside surface of the gusset panel 250 pivots toward the outside surface of the leading side end flap 232 and the inside surface of the gusset panel 250 pivots toward the inside surface of the bottom end flap 236. The bottom end flap 236 is partially folded as the side end flaps 232, 234 are folded inwardly towards the open end N so as to be substantially coplanar with one another. Thereafter, the bottom end flap 236 is additionally folded by a folding guide (not shown).

Depending on the position of the folding structure 130, the gusset panel 250 contacts the sloped surface 142 and moves past the tip end 145 of the folding structure 130 before or after the lower portion L of the bottom end flap 236 is folded by the folding guide. Lastly, the top end flap 230 is folded by a folding guide and the upper portion U of the bottom end flap 236 is folded along the fold line 248 and secured in an overlapping fashion over the top end flap 230.

### ALTERNATIVE EMBODIMENTS

In alternative embodiments, it is envisaged that the folding structure 130 can be secured to the flight bar 120 such that the position of the folding structure 130 is adjustable.

In an exemplary embodiment, the folding structures are static structures. However, it is envisaged that folding structures can be made to extend and retract to facilitate folding the end flaps and gusset panels of an exemplary carton by “breaking” a diagonal fold line that defines a gusset panel. The extension and retraction of the folding structures can be accomplished automatically and timed or phased with respect to the folding wheels or other folding elements of the folding station. For example, a cam track can be formed in the conveying surface, and rollers, which follow the cam track, can be connected to a mechanism that controls the extension of the folding structures. In such an alternative embodiment, there are fewer limitations on the dimensions and position of the folding structures.

The present invention has been illustrated in relation to a particular embodiment which is intended in all respects to be illustrative rather than restrictive. Those skilled in the art will recognize that the present invention is capable of many modifications and variations without departing from the scope of the invention. For example, as used herein, directional references such as top, base, bottom, end, side, inner, outer, upper, middle, lower, front, and rear do not limit the respective walls of the carton to such orientation, but merely serve to distinguish these walls from one another. Any reference to hinged connection should not be construed as necessarily referring to a junction including a single hinge only; indeed, it is envisaged that hinged connection can be formed from one or more potentially disparate means for hingedly connecting materials.

The above-described embodiments are merely exemplary illustrations of implementations set forth for a clear understanding of the principles of the invention. Variations, modifications, and combinations may be made to the above-described embodiments without departing from the scope of the claims. All such variations, modifications, and combinations are included herein by the scope of this disclosure and the following claims.

What is claimed is:

1. A system for folding cartons, comprising:
a carton conveyor for supporting and transporting cartons in a flow direction along a path, said carton conveyor comprising a conveying surface;
an active folding element for folding cartons;
a first flight bar and a second flight bar, said first flight bar having a first support surface and said second flight bar having a second support surface; wherein said conveying surface, said first support surface and said second support surface define a space for receiving a carton; and
at least one folding structure protruding from a plane defined by at least one of said support surfaces into said space, said at least one folding structure being positioned to contact a carton proximate to a fold line to facilitate folding the carton with said active folding element.

2. The system of claim 1, wherein said at least one folding structure is attached to one of said flight bars.

3. The system of claim 1, wherein said at least one folding structure is integral to one of said flight bars.

4. The system of claim 1, wherein the fold line is in an arrangement of end flaps of a carton.

5. The system of claim 4, wherein said arrangement includes a side end flap that is connected to a bottom end flap by a gusset panel.

6. The system of claim 5, wherein said at least one folding structure is positioned to contact a carton proximate to the fold line that hingedly connects said side end flap and said gusset panel.

7. The system of claim 1, wherein said first flight bar and said second flight bar are arranged along said path such that said first flight bar is positioned to support the leading side wall of a carton and said second flight bar is positioned to support the trailing side wall of a carton.

8. The system of claim 7, wherein said at least one of said support surfaces comprises said first support surface.

9. The system of claim 1, wherein said at least one folding structure protrudes from one of said flight bars toward the other of said flight bars.

10. The system of claim 1, wherein said at least one folding structure includes a downwardly sloped surface and an inwardly sloped surface.

11. The system of claim 1, wherein said at least one folding structure includes a tip end.

12. The system of claim 1, wherein the position of said at least one folding structure is adjustable.

13. The system of claim 1, wherein said active folding element is a folding wheel.

14. The system of claim 1, wherein said active folding element is for folding side end flaps of cartons.

15. A flight bar for use with a system for folding a carton that includes a carton conveyor, the flight bar for supporting a carton in an erected condition and translating a carton in a flow direction along a path, the flight bar comprising:
a support surface for at least partially defining a space for receiving a carton; and
at least one folding structure protruding from a plane defined by said support surface, said at least one folding structure being positioned to contact a carton proximate to a fold line to facilitate folding the carton with an active folding element of the system.

16. A method for folding end flaps of a carton to form an end closure structure, the method comprising:
placing a carton on a carton conveyor in a space defined by a conveyor surface, a first flight bar, and a second flight bar;
pre-folding a fold line in an arrangement of end flaps of the carton, the arrangement including a first side end flap and a bottom end flap that are connected by a first gusset panel, the fold line being pre-folded by a folding apparatus that protrudes into the space to contact the arrangement proximate the fold line; and
folding the first side end flap inward to further fold the arrangement along the fold line and at least partially form an end closure structure.

17. The method of claim 16, wherein the folding step comprises operating a folding element.

18. The method of claim 16, wherein the pre-folding step occurs by virtue of placing step.

19. The method of claim 16, further comprising folding the bottom end flap with a guide bar.
